(19) United States
(12) Patent Application Publication
(10) Pub. No.: US 2010/0083738 A1
(43) Pub. Date: Apr. 8, 2010

(54) Test Plug and Method for Monitoring Downstream Conditions

(75) Inventor: Frederick W. Padden, Williamsburg, VA (US)

Correspondence Address: HOWSON & HOWSON LLP, 501 OFFICE CENTER DRIVE, SUITE 210, FORT WASHINGTON, PA, 19034, US

(73) Assignee: EST GROUP, INC., Hatfield, PA (US)

(21) Appl. No.: 12/524,540

(22) PCT Filed: Jan. 26, 2007
(86) PCT No.: PCT/US07/02281

§ 371 Date: Aug. 4, 2009

(51) Int. Cl. G01M 3/04

(52) U.S. Cl. 73/49.8

(57) ABSTRACT

A test plug assembly (10, 50, 90) includes a shaft (24, 56, 100) on which an annular elastic seal (22, 68, 94) and compression elements (32, 34, 62, 106, 110) are mounted. The compression elements (32, 34, 62, 106, 110) confront opposite axial sides of the annular seal (22, 68, 94) and are movable relative to one another for axially compressing and radially expanding the seal (22, 68, 94) into fluid-tight sealing engagement with an inner peripheral wall (38, 70, 96) of a pipe (16, 52, 92). A transducer (42, 80, 122) is mounted on the distal end of the shaft (24, 56, 100) and measures a condition within the pipe (16, 52, 92) at a location beyond the seal (22, 68, 94). As one example, the transducer (42, 80, 122) is a temperature compensation pressure transducer for obtaining pressure measurements within the downstream portion of the pipe (16, 52, 92) beyond the test plug (10, 50, 90). The transducer (42, 80, 122) produces electrical signals and is in communication with a control unit (982) located externally of the pipe (16, 52, 92). The control unit (982) converts the electronic signals of the transducer (42, 80, 122) for driving a display apparatus (983) to provide visible or audible information and/or warning signals concerning the measurements. The control unit (982) is responsive to transducer signals for automatically terminating welding of a pipe when the signals indicate that pressure at the distal end of the shaft (24, 56, 100) beyond the seal (22, 68, 94) is at a prescribed undesired level.

### BACKGROUND OF THE INVENTION

The present invention relates to test plugs for sealing open ends of pipes, tubes, pressure vessels and the like and/or for forming seals at locations on opposite sides of welded-connections, and more particularly, the present invention relates to a test plug that permits conditions within the pipe beyond the test plug to be monitored.

Examples of test plugs for testing pipes, tubes, vessels, and the like for leaks are disclosed by U.S. Pat. Nos. 6,675,634 B2 and 5,676,174 issued to Berneski, Jr. et al., International PCT Publication No. WO 00/03172 of Berneski, Jr. et al., and 5,797,431 issued to Adams. In addition, see U.S. Pat. No. 5,024,079 issued to Dufort for an example of a flange weld test plug and U.S. Pat. Nos. 5,844,127 and 6,131,441 issued to Berube et al. for examples of so-called double-block-and bleed, or dumbbell, test plugs.

Conditions, such as pressure, within a section of pipe located beyond the distal end of a test plug are typically required to be monitored for safety and/or testing purposes. A typical test plug has a ported central shaft that extends longitudinally through the test plug and that communicates with inlet and outlet ports on opposite ends of the plug. Accordingly, an open pathway is provided through the full length of the plug permitting venting from a position within the pipe adjacent a distal end of the test plug to a proximal end of the test plug. A pressure gauge is connected to the outlet of the ported center shaft adjacent a proximal end of the test plug at a location external of the pipe. This permits pressure within the pipe behind the test plug to be monitored.

While the above-described test plugs may function satisfactorily under certain conditions, a problem with them is that the vent passageways require precision machining processes and are complex, time-consuming and costly to manufacture and maintain. The vent passageways are also subject to the problem of clogging by material in the pipe. Such clogging decreases measurement accuracy and increases maintenance. Accordingly, there is a recognized need for a test plug which enables pressure buildup and/or other conditions behind the test plug to be monitored with greater accuracy. A desired plug should be less expensive to manufacture, require a reduced amount of maintenance, enable warning signals to be produced when pressure or other conditions behind the plug reaches pre-determined levels, and/or enable automatic turn-off of operations, such as welding.

### SUMMARY OF THE INVENTION

The foregoing problems are solved and a technical advance is achieved by illustrative embodiments of the invention which eliminate the need for the prior art vent through the full length of the test plug for venting and pressure measurements advantageously while providing for the monitoring of pressure downstream in the pipe, the display of pressure measurements in real-time, and for the automatic turn-off of operations, such as welding, when that pressure reaches a predetermined threshold. The elimination of the prior art vent reduces the required time and complexity of the test plug machining process and overall manufacturing and maintenance cost. Improved accuracy is achieved by positioning apparatus, such as a transducer, about a distal end of a shaft of the test plug and downstream in the pipe for measuring a condition, such as pressure, and converting it to an electrical signal that cooperates with a control unit located external to the pipe to drive a display which visually and/or audibly indicates the measurement in real-time. Improved safety is achieved by the transducer cooperating with the control unit to control a turn-off device for automatically terminating operations, such as welding, when the measured pressure exceeds a threshold. Such an arrangement enables personnel to take appropriate action to reduce the possibility of a forced plug expulsion from the pipe. Safety is further improved by a power control circuit, which gradually increases and decreases the magnitude of power applied to and withdrawn from the control unit and transducer whereby possible explosive conditions about the transducer are reduced.

The present invention provides a test plug assembly including an elongate shaft carrying an annular elastic seal and compression elements thereon. The compression elements confront opposite axial sides of the annular seal and are movable relative to one another for axially compressing and radially expanding the elastic seal into fluid-tight sealing engagement with an inner peripheral wall of a pipe. Apparatus is mounted on the distal end of the shaft for measuring a condition within the pipe behind the seal of the test plug and for converting the measurement into a signal transmittable to a control unit positioned externally of the pipe. The control unit is responsive to the signals to drive a display apparatus to provide visual or audible presentation of the measurement in real-time. As one contemplated example of the present invention, the apparatus is a temperature compensation pressure transducer for obtaining pressure, measurements within a downstream portion of the pipe beyond the test plug. The control unit is further responsive to transducer signals to control an automatic turn-off device to terminate further pipe welding, for example, when the pressure exceeds a prescribed threshold.

According to another aspect of the present invention, a test plug assembly is provided that has a shaft carrying a longitudinally spaced pair of annular elastic seals and compression elements that confront opposite axial sides of the annular seals. The compression elements are movable relative to one another for axially compressing and radially expanding the seals into fluid-tight sealing engagement with an inner periphery of a pipe to define a sealed chamber. The test plug also includes a conduit for applying a predetermined pressure to the chamber and a transducer positioned in the vicinity of the distal end of the shaft for monitoring pressure within the pipe beyond the seals and for converting the monitored pressure into transmittable signals.

The present invention advantageously provides a method for measuring pressure and like conditions in a downstream portion of a pipe beyond the seals of a test plug. The method utilizes a transducer to obtain measurements and electronically transmit the information to a control unit which controls a display of the measurements and/or provides a warning indication when measured conditions reach a pre-set level. The method also controls the gradual increase and decrease of start-up and turn-off of power to the transducer within a pipe environment.

### BRIEF DESCRIPTION OF THE DRAWINGS

The features of the present invention should become apparent from the following description when taken in conjunction with the accompanying drawings, in which:

FIG. 1 is a perspective view of flange weld test plug according to the present invention;

FIG. 2 is a cross-sectional view of the flange weld test plug of FIG. 1 positioned within the end of a pipe;

FIG. 3 is a cross-sectional view of the flange weld test plug of FIG. 2 in which the seal of the test plug has been expanded into sealing relationship with the inner wall of the pipe;

FIG. 4 is a cross-sectional view of a dumbbell, or double-block-and-bleed, test plug positioned within a pipe;

FIG. 5 is a cross-sectional view showing a pair of seals of the test plug of FIG. 4 in sealing relationship with the inner wall of the pipe on opposite sides of a weld;

FIG. 6 is a cross-sectional view of a hydrostatic test plug according to the present invention;

FIG. 7 is a partial cross-sectional view of a shaft of the hydrostatic test plug of FIG. 6;

FIG. 8 is a partial cross-sectional view of hydrostatic test plug having a transducer according to the present invention; and

FIG. 9 is a schematic of the transducer and the control, display, automatic turn-off, and power turn-on and off elements of the display unit.

### DETAILED DESCRIPTION OF THE INVENTION

The present invention can be utilized in various types of test plugs including, but not limited to, flange weld test plugs, double-block-and-bleed test plugs, and hydrostatic test plugs, as will be discussed in detail below. Typically, the test plugs are used in procedures to complete or repair a welded or other connection between two hollow or tubular parts or to test the connection, the pipe, or a piping system. Such procedures typically involve the steps of sealing a section of a pipe, tube, vessel, or the like at a location adjacent an open end thereof and pressurizing the sealed section of the pipe, tube or vessel with a fluid such as gas, including air or nitrogen, or a liquid such as a hydraulic fluid. In some procedures, pressure may buildup within the pipe, tube, or vessel behind the test plug to undesired or dangerous levels. Accordingly, conditions within a section of the pipe, tube, or vessel that are isolated behind the seals of the test plug should be continuously monitored during most procedures. The test plugs according to the present invention provide a means for readily and accurately monitoring such conditions.

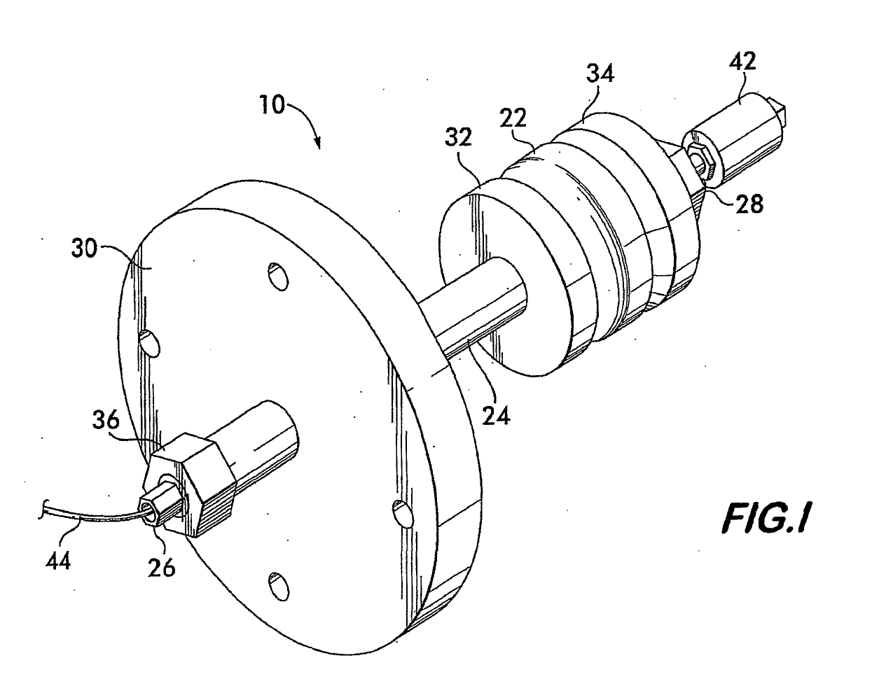

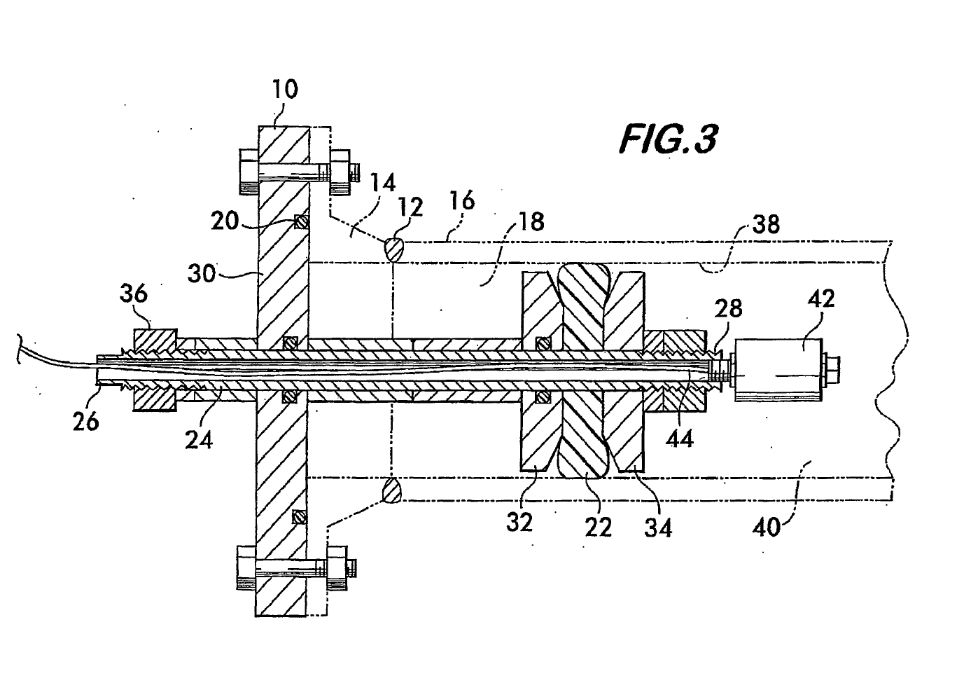

As a first embodiment of the present invention, a flange weld test plug 10 is illustrated in FIGS. 1-3. The test plug 10 is used, for example, in hydraulic pressure and leak testing procedures performed on an annular weld 12 connecting a neck flange 14 to an end of a pipe 16. See FIG. 3. The flange weld test plug 10 is also used during procedures to complete or repair the weld 12 when installing, repairing, or retrofitting the pipe 16 with the neck flange 14. The test plug 10 permits these procedures to be performed without the necessity of filling and pressurizing the entire piping system. Only a section 18 of the pipe 16 between a pair of seals 20 and 22 of the test plug 10 is pressurized.

The flange weld test plug 10 includes an elongate shaft 24 defining proximal and distal ends, 26 and 28, of the plug 10. A front flange plate 30 is carried on the proximal end 26 of the shaft 24 and is adapted to be connected to the neck flange 14 in a manner forming a fluid-tight seal therebetween. A pair of compression elements, or plates, 32 and 34, is carried on the distal end 28 of the shaft 24 and sandwich the flexible, elastic annular seal 22 therebetween. Tightening or loosening a threaded fastener, nut, or like mechanism 36 on the proximal end 26 of the shaft 24 causes the compression plates, 32 and 34, to advance or retract relative to one another thereby compressing or releasing from compression the flexible, elastic annular seal 22.

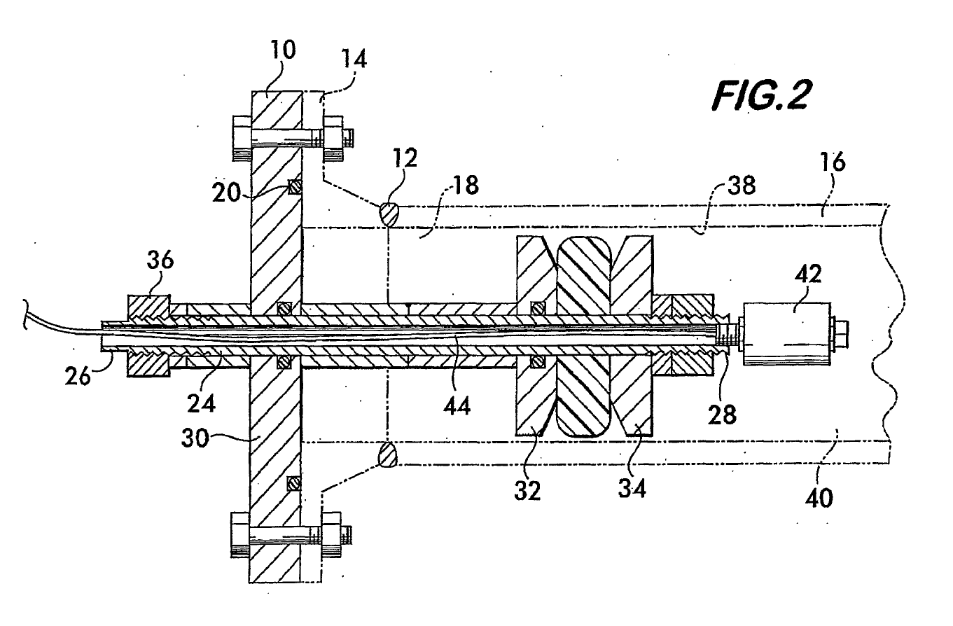

When the seal 22 is an uncompressed state as shown in FIG. 2, the distal end 28 of the plug 10 is inserted into the neck flange 14 and pipe 16 such that the plug 10 seals the open end of the neck flange 14 and locates the annular seal 22 on an opposite side of the weld 12. Thereafter, the annular seal 22 is caused to be axially compressed by the compression plates, 32 and 34, until the seal 22 is squeezed radially outward and forms a fluid-tight seal with the inner diameter surface 38 of the pipe 16. See FIG. 3.

During formation, completion, or repair of the weld 12, the plug 10 isolates the weld area from a downstream portion 40 of the pipe 16 and enables the weld area to be purged, for instance, with nitrogen. Thereafter, the weld 12 can be completed or repaired and then tested. During testing, fluid, such as water, is admitted through the plug 10 to the pipe section 18 between the seals 20 and 22 to pressurize the pipe section 18. After the test, the pipe section 18 is depressurized, the seal 22 is permitted to return to an uncompressed state as illustrated in FIG. 2, and the test plug 10 is withdrawn from the open end of the neck flange 14.

The plug 10 according to the present invention includes a transducer 42 mounted on the distal end 28 of the plug 10. Accordingly, when the plug 10 is positioned within the pipe 16, the transducer 42 extends within the downstream portion 40 of the pipe 16 beyond the seals, 20 and 22, of the test plug 10. See FIG. 3. The transducer 42 enables highly accurate measurements to be taken of selected conditions within the downstream portion 40 of the pipe 16. According to one contemplated example of the present invention, the transducer 42 is a temperature compensation pressure transducer that provides extremely accurate measurements of the pressure within the downstream portion 40. For instance, the transducer 42 can provide measurements accurate within ±0.3% of pressure within a range of 0 to 5,000 psi. Of course, transducers for measuring other physical conditions or the presence or lack thereof of selected substances can also be utilized.

The transducer 42 converts the measurement into an electric signal which is transmitted through the test plug 10 to a display unit or like device located externally of the pipe. For example, the display unit can be a portable digital display unit that converts the electric signal into a visual and/or audible representation of the measurement in real-time. The signal can be transmitted for instance, through a cable, hard wire, or the like 44 extending longitudinally through the plug 10 and physically connecting the transducer 42 to the display unit. As an alternative to the use of the cable 44, a transducer providing wireless communication of the signal to a receiver of the display unit can also be utilized. The above described arrangements enable accurate information of upstream pressure or other conditions to be continuously monitored in real time during a testing or other procedure.

If the condition or pressure within the downstream portion 40 reaches an undesired or dangerous level, the transducer 42 and/or display unit causes a visible or audible warning signal to be produced. For example, a warning signal or the like is automatically triggered upon the measured condition reaching a pre-set level.

As illustrated in FIG. 2, the transducer 42 has a threaded end that is secured to the distal end 28 of the shaft 24. This seals the hollow shaft from conditions in the downstream portion 40 of the pipe 16. Accordingly, required maintenance of the plug 10 is reduced due to the elimination of the potential for the hollow central shaft to become clogged or contaminated.

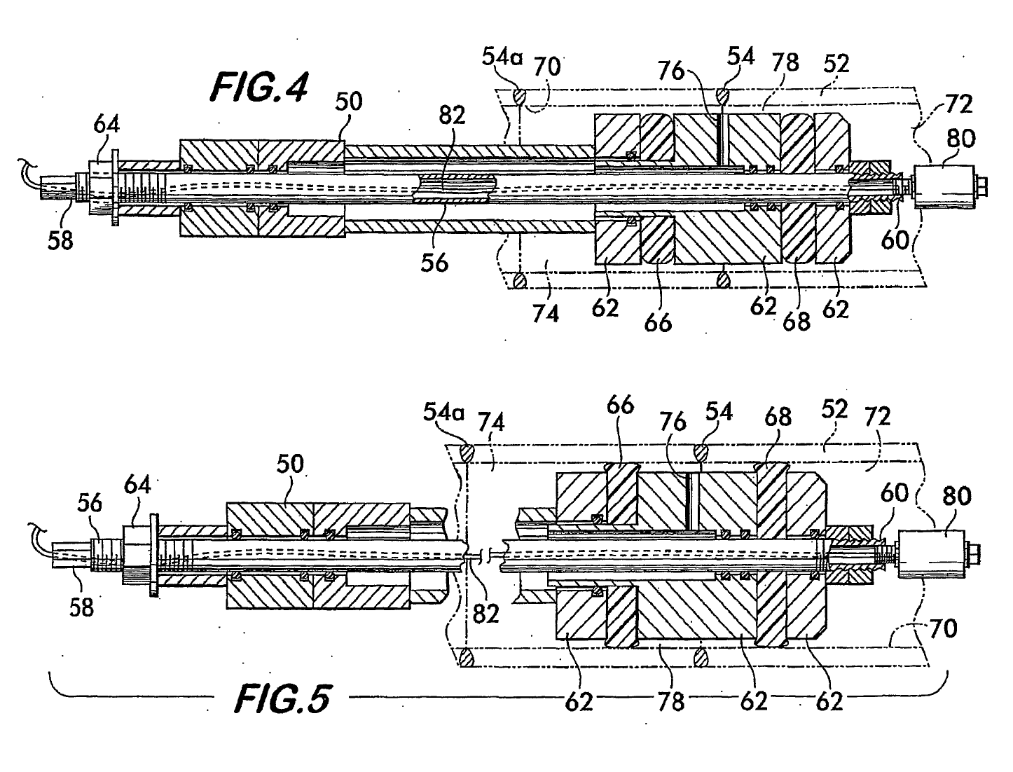

As a second embodiment of the present invention, a double-block-and-bleed (DBB) test plug 50 is illustrated in FIGS. 4 and 5. Such a plug 50 can be inserted into an open end of a pipe 52 to test or complete a welded connection 54 that joins a pair of pipes.

The DBB test plug 50 includes an elongate shaft 56 extending between proximal and distal ends, 58 and 60, of the plug 50. A series of compression elements, or plates, 62 are located adjacent the distal end 60 of the plug 50. A mechanism, such as a threaded fastener or nut 64, provided on the proximal end 58 of the shaft 56 is capable of being advanced or retracted on the shaft 56 to result in the series of compression elements 62 to advance or retract relative to one another. Separate flexible elastic annular seals 66 and 68 are located at longitudinally spaced positions on the shaft 56 and are sandwiched by the series of compression elements 62. Accordingly, when the compression plates, 32 and 34, are advanced or retracted relative to one another, the flexible annular seals 66 and 68 are compressed or released from a compressed state.

When the seals, 66 and 68, are not compressed as shown in FIG. 4, the distal end 60 of the plug 50 is inserted into the open end of pipe 52 such that the seals 66 and 68 are positioned on opposite sides of the weld 54. Thereafter, the annular seals, 66 and 68, are caused to be axially compressed by the series of compression elements 62 until the seals, 66 and 68, are squeezed radially outward and form fluid-tight seals with the inner diameter surface 70 of the pipe 52. See FIG. 5.

During formation, completion, or repair of the weld 54, the plug 50 isolates the weld area from downstream and upstream pipe sections, 72 and 74, and enables the weld area to be purged, for instance, with nitrogen. Thereafter, the weld 54 can be completed or repaired and then tested. During testing, fluid, such as water, is admitted through the proximal end 58 of the plug 50 and through a port 76 to an isolated pipe section 78 located between the seals, 66 and 68, to pressurize pipe section 78. After the test, the pipe section 78 is depressurized, the seals 66 and 68 are returned to an uncompressed state as illustrated in FIG. 4, and the test plug 50 is withdrawn from the open end of the pipe 52.

The plug 50 according to the present invention includes a transducer 80 mounted on the distal end 60 of the plug 50. The transducer 80 provides a similar function with respect to plug 50 as that discussed above with respect to transducer 42 and plug 10. Pressure or another condition existing in the downstream section 72 beyond the test plug 50 is accurately measured by the transducer 80. The measurements are transferred by a cable 82 or like means to a digital readout (not shown) or like device so that the pressure or condition can be monitored during a testing procedure. Preferably, the digital readout or like device emits visible and/or audible warning signals when pre-determined levels are reached.

The DBB plug assembly is also useful for isolating a downstream segment of a pipe away from a hot spot weld site, such as for the weld 54a in FIGS. 4 and 5. Such a use ensures that welding is isolated from vapors downstream in the pipe and is initiated after a determination is made that an undesired leakage of seals 66 and/or 68 does not exist and is interrupted when such leakage is detected. After an insertion of plug 50 into the pipe 52 and the expansion of the seals 66 and 68, as priorly described and as shown in FIGS. 4 and 5, to define a fluid-tight sealing chamber area, a predetermined installation pressure is applied to that chamber via port 76 for a predetermined time and is then sealed off. Thereafter, chamber pressure monitor 986 of FIG. 9 measures that pressure when it is switched on via switch 987 to drive control circuit 982 via cable 988. Concurrently, the transducer 980 of FIG. 9 (80 in FIGS. 4 and 5) monitors the downstream pressure within pipe 52 and converts the monitored pressure into electrical signals for driving control circuit 982. The latter controls a determination of leakage conditions in the chamber area and thus the integrity of seals 66 and 68. When no undesired leakage exists, circuit 982 determines that the chamber pressure is higher than the downstream pressure measured by transducer 980 and activates the display 983 to so indicate. Thus, no downstream vapors escape beyond the seals 66 and 68 and welding operations to produce the weld 54a may commence under satisfactory isolation conditions. On the other hand, if the seals 66 and/or 68 are leaking, circuit 982 determines that the measured pressure in the chamber area is less than the pressure monitored by transducer 980 and causes the display apparatus 983 to visually and/or audibly report the leakage condition to personnel. Under such conditions, circuit 982 drives the turn-off apparatus 984 to automatically turn-off welding operations, whereby an initiation or continuance of potentially dangerous welding is minimized.

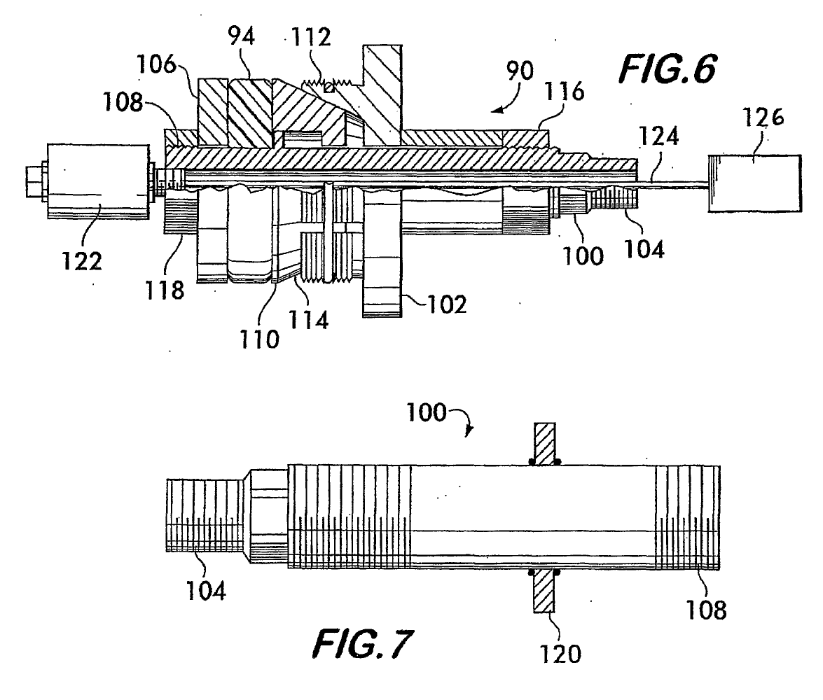

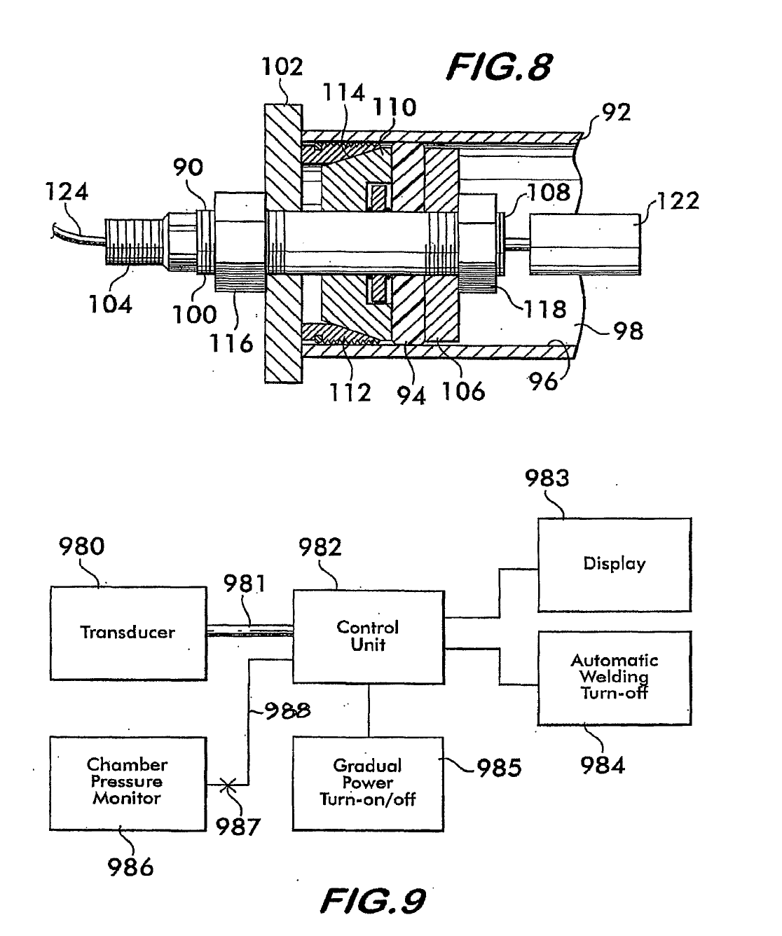

As a third embodiment of the present invention, a hydrostatic or high pressure test plug 90 is illustrated in FIGS. 6 and 8. The test plug 90 is used to seal the open end of a pipe 92 to enable a pressure test to be run on the pipe 92 and/or an entire piping system. The hydrostatic test plug 90 includes an annular elastic seal 94 capable of being axially compressed so that it expands radially into sealing engagement with an inner peripheral surface 96 of the pipe 92. A portion 98 of the pipe 92 extending behind the seal 94 is pressurized and tested.

The test plug 90 includes a shaft 100 that carries an annular front wall 102 adjacent a proximal end 104 of the plug 90 and a rear compression washer 106 adjacent a distal end 108 of the plug 90. A cone-shaped or frustoconical washer 110 is supported on the shaft 100 intermediate the annular wall 102 and compression washer 106. A set of segmented grippers 112 is supported on a tapered section 114 of the cone-shaped washer 110 and bridges the gap between the annular wall 102 and cone-shaped washer 110. When the gap between the annular wall 102 and cone-shaped washer 110 is reduced, the set of segmented grippers 112 is driven radially outward into engagement with the inner peripheral surface 96 of the pipe 92 thereby securing the plug 90 within the pipe 92. The annular seal 94 is carried on the shaft 100 between the cone-shaped washer 110 and the compression washer 106. When the gap between the compression washer 106 and cone-shaped washer 110 is reduced, the annular seal 94 is squeezed radially outward and forms a fluid-tight seal with the inner peripheral surface 96 of the pipe 92.

Preferably, the shaft 100 is threaded as best illustrated on FIG. 7, and threaded fasteners, 116 and 118, are secured on opposite ends of the shaft 100. The position of the fastener 116 on the proximal end 104 of the plug 90 is advanced or retracted on the shaft 100 to cause the plug assembly to compress or retract. The shaft 100 shown in FIG. 7 has an annular flange 120 receivable within a recess in the cone-shaped washer 110 to aid in properly positioning the washer 110 on the shaft 100. In an alternative embodiment, the annular flange 120 is eliminated.

During use, the assembly of components on the shaft 100 is sufficiently retracted to permit the distal end 108 of the plug 90 to be inserted within an open end of the pipe 92. The fastener 116 is tightened to compress the assembly causing the grippers 112 to bite into the surface 96 of the pipe 92 and causing the seal 94 to expand into engagement with the surface 96 of the pipe 92 to form a fluid-tight seal. Thereafter, the section 98 of the pipe downstream of the seal 94 is pressurized and tested. As the test pressure is increased, the pressure acts on the rear compression washer 106 to further compress the plug assembly and drive the grippers 112 and/or seal 94 into tighter engagement with the pipe 92. After the test is concluded, the pipe 92 is depressurized, the fastener 116 is loosened, and the seal 94 and grippers 112 retract into their original position to permit removal of the test plug 90 from the pipe 92.

Similar to plugs 10 and 50, plug 90 according to the present invention includes a transducer 122 mounted on the distal end 108 of the plug 90. The transducer 122 provides a similar function to that of transducer 42 of plug 10. Pressure or another condition existing in the downstream section 98 of the pipe 92 beyond the test plug 90 is accurately measured by the transducer 122. The measurements are transferred by a cable 124 or like means to a portable digital readout or like display device 126 so that the pressure or condition can be monitored during a pipe testing procedure. Preferably, when pre-determined levels are reached, the digital readout or like device 126 emits visible and/or audible warning signals.

FIG. 9 depicts the illustrative circuitry for measurement, control, display, welding turn-off, and power-up and down operations of the present invention. In FIG. 9, transducer 980 communicates electrical signals representative of measured pressure illustratively over cable 981 to a control unit 982, which, in turn, drives display apparatus 983 to display real-time measurements of transducer 980. The control unit 982 further drives the turn-off apparatus 984 to automatically turn-off further welding operations when transducer measurement reaches a predetermined level. The magnitude of operating power is gradually applied and withdrawn from transducer 980 and control unit 982 by power control unit 985 to reduce dangerous conditions within the pipe.

In view of the foregoing, it should be apparent that the present invention now provides a test plug that provides highly accurate measurements of pressure and like conditions existing within a pipe or vessel behind the seals of the plug. Although the use of electrical signals has been described above, the use of optical signals via fiber-optic and other light-transmitting cables and other signals can also be utilized.

While a preferred embodiment of the present invention has been described in detail, various modifications, alterations, and changes may be made without departing from the spirit and scope of the present invention as defined in the appended claims.

1. A test plug assembly (10, 50, 90), comprising:
a shaft (24, 56, 100) having a proximal end and a distal end;
an annular elastic seal (22, 68, 94) carried on said shaft (24, 56, 100) between said proximal and distal ends;
compression elements (32, 34, 62, 106, 110) carried on said shaft (24, 56, 100) and confronting opposite axial sides of said annular seal (22, 68, 94), said compression elements (32, 34, 62, 106, 110) being movable relative to one another for axially compressing and radially expanding said seal (22, 68, 94) into fluid-tight sealing engagement with an inner periphery (38, 70, 96) of a pipe (16, 52, 92); and
apparatus (42, 80, 122) positioned about said distal end of said shaft (24, 56, 100) for measuring a condition within the pipe (16, 52, 92) beyond said seal (22, 68, 94) and for converting the measurements into transmittable signals.

2. A test plug assembly (10, 50, 90) according to claim 1, wherein said apparatus (42, 80, 122) is mounted on said distal end of said shaft (24, 56, 100) and is a transducer for measuring pressure, and wherein said transmittable signals are electric signals.

3. A test plug assembly (10, 50, 90) according to claim 1, wherein said apparatus (42, 80, 122) extends from said distal end of said shaft (24, 56, 100) and is a temperature compensation transducer for measuring pressure.

4. A test plug assembly (10, 50, 90) according to claim 2, further comprising a control unit (982) located externally of the pipe (16, 52, 92) and in communication with said transducer (42, 80, 122) for receiving said electric signals for controlling a visual or audible display of the pressure measurements of said transducer (42, 80, 122); and means (44, 82, 124) coupling said transducer electric signals, through said shaft (24, 56, 100), and to said control unit (982).

5. (canceled)

6. A test plug assembly (10, 50, 90) according to claim 4, wherein said control unit (982) provides a warning signal when said pressure measurement exceeds a pre-set threshold level for controlling an audible or visual display of said pressure measurement.

7. (canceled)

8. A test plug assembly (50) according to claim 1, wherein said test plug (50) has a longitudinally spaced pair of annular elastic seals (66, 68) on said shaft (56) that are each axially compressible and radially expandable into fluid-tight sealing engagement with the inner periphery (70) of the pipe (52).

9. A test plug assembly (90) according to claim 1, further comprising a set of segmented grippers (112) that are radially expandable into engagement with the inner periphery (96) of the pipe (92) to secure the test plug (90) to the pipe (92), wherein one of said compression elements (110 has an inclined surface (114) remote from said seal (94), and wherein said set of segmented grippers (112) confront said inclined surface (114) and travel along said inclined surface (114) between expanded and retracted positions.

10-11. (canceled)

12. A pipe and test plug assembly (10, 16, 50, 52, 90, 92), comprising:
a pipe (16, 52, 92) having an open end and an inner peripheral wall (38, 70, 96);
a test plug (10, 50, 90) having a shaft (24, 56, 100) with a distal end receivable within said open end of said pipe (16, 52, 92);
an annular elastic seal (22, 68, 94) carried on said shaft (24, 56, 100) adjacent said distal end;
compression elements (32, 34, 62, 106, 110) carried on said shaft (24, 56, 100) and confronting opposite axial sides of said annular seal (22, 68, 94), said compression elements (32, 34, 62, 106, 110) being movable relative to one another for axially compressing and radially expanding said seal (22, 68, 94) into fluid-tight sealing engagement with said inner peripheral wall (38, 70, 96) of said pipe (16, 52, 92); and
a transducer (42, 80, 122) mounted on said distal end of said shaft (24, 56, 100) for measuring a condition within the pipe (16, 52, 92) at a location beyond said seal, said transducer (42, 80, 122) measuring pressure and converting measurements into electric signals.

13. (canceled)

14. A pipe and test plug assembly (10, 16, 50, 52, 90, 92) according to claim 12, further comprising a control unit (982) located externally of said pipe (16, 52, 92) and in communication with said transducer (42, 80, 122) for controlling a display of pressure measurements of said transducer (42, 80, 122) in real-time; and an electric cable (44, 82, 124) extending from said transducer (42, 80, 122), through said shaft (24, 56, 100), and to said control unit (982) for communicating said electric signals of said transducer (42, 80, 122) to said control unit (982).

15. (canceled)

16. A pipe and test plug assembly (10, 16, 50, 52, 90, 92) according to claim 14, wherein said control unit (982) provides an audible or visual indication of said transducer measurements in real time.

17. (canceled)

18. A pipe and test plug assembly (50, 52) according to claim 12, wherein said test plug (50) has a longitudinally spaced pair of annular elastic seals (66, 68) on said shaft (56) that are each axially compressible and radially expandable into fluid-tight sealing engagement with said inner peripheral wall (70) of said pipe (52).

19. A pipe and test plug assembly (90, 92) according to claim 14, further comprising a set of segmented grippers (112) that are radially expandable into engagement with said inner peripheral wall (96) of said pipe (92) to secure said test plug (90) to said pipe (92), wherein one of said compression elements (110) has an inclined surface (114) remote from said seal (94), and wherein said set of segmented grippers (112) confront said inclined surface (114) and travel along said inclined surface (114) between expanded and retracted positions.

20. (canceled)

21. A method of monitoring a condition within a pipe (16, 52, 92) beyond a test plug (10, 50, 90), comprising the steps of
inserting a distal end of the test plug (10, 50, 90) into an open end of the pipe (16, 52, 92);
after said inserting step, axially compressing and radially expanding an elastic seal (22, 68, 94) of the test plug (10, 50, 90) into fluid-tight sealing engagement with an inner peripheral wall (38, 70, 96) of the pipe (16, 52, 92); and
monitoring a condition within the pipe (16, 52, 92) beyond the seal (22, 68, 94) with a transducer (42, 80, 122) extending from the distal end of the test plug (10, 50, 90).

22. A method according to claim 21, wherein said transducer (42, 80, 122) is a transducer for measuring the pressure within the pipe (16, 52, 92) beyond the seal (22, 68, 94), and wherein said monitoring step includes monitoring a display unit (126, 983) which is located externally of the pipe (16, 52, 92) and which displays measurements in real-time obtained by the transducer (42, 80, 122).

23. A method according to claim 22, wherein said test plug (10, 50, 90) comprises a flange weld test plug (10), a hydrostatic test plug (90), or a double block and bleed test plug (50); wherein said monitoring comprises monitoring pressure within the pipe (16, 52, 92) at a distal end of the test plug (10, 50, 90) with a pressure transducer (42, 80, 122) and producing signals indicative of the monitored pressure; and further comprising the step of communicating the transducer produced signals through the test plug (10, 50, 90) for controlling a display of humanly detectable signals indicative of the monitored pressure; and further comprising the step of gradually applying and withdrawing the magnitude of operating power to the transducer (42, 80, 122) to initiate and terminate said monitoring.

24. (canceled)

25. A test plug assembly (50), comprising:
a shaft (56) having a proximal end (58) and a distal end (60);
a longitudinally spaced pair of annular elastic seals (66, 68) carried on said shaft (56) that are each axially compressible and radially expandable into fluid-tight sealing engagement with the inner periphery (70) of the pipe (52) to define a sealed chamber (78) therein;
compression elements (62) carried on said shaft (56) and conforming opposite axial sides of said annular seals (66, 68), said compression elements (62) being movable relative to one another for axially compressing and radially expanding said seals (66, 68) into fluid-tight sealing engagement with the inner periphery (70) of the pipe (52) to define the sealed chamber (78);
a conduit (76) for applying a predetermined pressure to said chamber (78);
a transducer (80) positioned in the vicinity of said distal end (60) of said shaft (56) for monitoring pressure within the pipe (52) beyond said seals (66, 68) and for converting the monitored pressure into transmittable signals; and
means (986) for measuring the pressure in said chamber (78) and controllable by transmitted signals from said transducer (80) to indicate leakage conditions of said chamber (78).

26. (canceled)

27. A test plug assembly (50) according to claim 25, wherein said measuring means (986) indicates an absence of leakage in said chamber (78) when the pressure in said chamber (78) is greater than the pressure monitored by said transducer (80).

28. A test plug assembly (50) according to claim 25, wherein said test plug (50) is mountable downstream in a pipe (52) from a segment (54a) of the pipe (52) to be welded and wherein said measuring means (986) indicates a pressure leakage condition of said chamber (78) when the pressure in said chamber (78) is less than the pressure monitored by said transducer (80).

29. A test plug assembly (50) according to claim 28, further comprising apparatus (984) controllable by said measuring means (986) for automatically interrupting welding operations in response to said pressure leakage condition.

30. A method of monitoring a condition within a pipe (16, 52, 92) beyond a test plug (10, 50, 90) according to claim 1 comprising the steps of:
inserting the distal end of said plug (10, 50, 90) into an open end of said pipe (16, 52, 92);
after said inserting step, axially compressing and radially expanding said elastic seal (22, 68, 94) of said test plug (10, 50, 90) into fluid-tight sealing engagement with the inner wall (38, 70, 96) of said pipe (16, 52, 92); and
monitoring a condition within said pipe (16, 52, 92) beyond said seal (22, 68, 94) with said apparatus (42, 80, 122) comprising a transducer extending from said distal end of said shaft (24, 56, 100) and converting the measurements into said transmittable signals.
